(19) United States
(12) Patent Application Publication
(10) Pub. No.: US 2026/0086479 A1
(43) Pub. Date: Mar. 26, 2026

(54) FIXING DEVICE

(71) Applicant: CANON KABUSHIKI KAISHA, Tokyo (JP)

(72) Inventors: EITA KAWASAKI, Kanagawa (JP); TAKASHI KIMURA, Tokyo (JP); GOSHI OZAKI, Kanagawa (JP); MIKA MAEJIMA, Tokyo (JP); MASAFUMI MAEDA, Kanagawa (JP); KENICHI TAGAMI, Tokyo (JP)

(21) Appl. No.: 19/324,894

(22) Filed: Sep. 10, 2025

(30) Foreign Application Priority Data
Sep. 20, 2024 (JP) 2024-164403

(51) Int. Cl. G03G 15/20

(52) U.S. Cl. CPC G03G 15/2032; G03G 15/2064; G03G 2215/2035

(57) ABSTRACT

A transmission member includes a facing portion configured to face, out of edges forming a recess portion of a frame, an edge located on a downstream side of a center of a fixing nip portion in a recording material conveying direction, the facing portion is provided with a first protrusion that protrudes toward the edge on the downstream side in the recording material conveying direction and a second protrusion that is provided at a position different from a position of the first protrusion in a first direction and that protrudes toward the edge on the downstream side in the recording material conveying direction, and, when a pressure roller rotates in a state where the fixing nip portion is formed, both the first protrusion and the second protrusion are configured to come in contact with the edge on the downstream side in the recording material conveying direction.

### BACKGROUND

### Field of the Technology

The present disclosure relates to a fixing device provided in an image forming apparatus using an electrophotography method.

### Description of the Related Art

In an image forming apparatus using an electrophotography method, a fixing device that employs an on-demand fixing method is discussed in Japanese Patent Laid-Open No. 2024-31208.

### SUMMARY

The present disclosure provides further development of conventional techniques and methods.

An aspect of the present disclosure provides a fixing device that includes a heating unit, a pressure roller, a frame and a pressure arm. The heating unit includes a belt having a tubular shape; a heater disposed in an internal space of the belt; a holder configured to hold the heater; a stay that is disposed to be in contact with the holder and that is configured to reinforce the holder, the stay including a first end and a second end; and a transmission member that is disposed, when viewed from a direction orthogonal to a longitudinal direction of the belt, at a position overlapping with the first end and the second end of the stay, and that is configured to apply, to the stay, pressure in a direction from the stay toward the heater. The pressure roller is in contact with an outer peripheral surface of the belt, the belt is sandwiched between the pressure roller and the heater, forming a fixing nip portion between the pressure roller and the belt. The frame is configured to hold the heating unit by holding the pressure roller so as to allow the pressure roller to rotate and to hold the transmission member, the frame including a recess portion to mount the transmission member. The pressure arm is pivotably provided in the frame and is configured to apply the pressure to the transmission member mounted on the frame. The fixing device is configured to fix a toner image to the recording material while nipping and conveying the recording material in the fixing nip portion. A material of the frame is resin. The frame has a pivot central axis to support pivoting of the pressure arm. When viewed from the longitudinal direction, the pivot central axis is located on an upstream side of the fixing nip portion in a recording material conveying direction and between, in a first direction orthogonal to the longitudinal direction and the recording material conveying direction, a rotation center of the pressure roller and an end of the holder positioned away from the rotation center of the pressure roller in the first direction. The transmission member includes a facing portion configured to face, from among a plurality of edges forming the recess portion of the frame, an edge located on a downstream side of a center of the fixing nip portion in the recording material conveying direction. The facing portion is provided with a first protrusion that protrudes toward the edge located on the downstream side in the recording material conveying direction and a second protrusion that is provided at a position different from a position of the first protrusion in the first direction and that protrudes toward the edge located on the downstream side in the recording material conveying direction. When the pressure roller rotates in a state where the fixing nip portion is formed, both the first protrusion and the second protrusion are configured to contact with the edge located on the downstream side in the recording material conveying direction.

According to another aspect of the present disclosure, a fixing device includes a heating unit, a pressure roller, a frame and a pressure arm. The heating unit includes a belt having a tubular shape; a heater disposed in an internal space of the belt; a holder configured to hold the heater; a stay that is disposed to be in contact with the holder and that is configured to reinforce the holder, the stay including a first end and a second end arranged along the longitudinal direction; and a transmission member that is disposed, when viewed from a direction orthogonal to a longitudinal direction of the belt, at a position overlapping with the first end and the second end of the stay, and that is configured to apply, to the stay, pressure in a direction from the stay toward the heater. The pressure roller is in contact with an outer peripheral surface of the belt, and the belt is sandwiched between the pressure roller and the heater, forming a fixing nip portion between the pressure roller and the belt. The frame is configured to hold the heating unit by holding the pressure roller so as to allow the pressure roller to rotate and to hold the transmission member. The pressure arm is pivotably provided in the frame and is configured to apply the pressure to the transmission member mounted on the frame. The fixing device is configured to fix a toner image to the recording material while nipping and conveying the recording material in the fixing nip portion. A material of the frame is resin. The frame includes a pivot central axis to support pivoting of the pressure arm. When viewed from the longitudinal direction, the pivot central axis is located on an upstream side of the fixing nip portion in a recording material conveying direction and between, in a first direction orthogonal to the longitudinal direction and the recording material conveying direction, a rotation center of the pressure roller and an end of the holder positioned away from the rotation center of the pressure roller in the first direction. The holder includes, at a position at which the transmission member is provided in the longitudinal direction, a first surface located on the upstream side of the fixing nip portion in the recording material conveying direction and a second surface located on a downstream side of the fixing nip portion in the recording material conveying direction. The transmission member includes a first facing portion provided on the upstream side of the first surface in the recording material conveying direction and facing the first surface, and a second facing portion provided on the downstream side of the second surface in the recording material conveying direction and facing the second surface. The first facing portion and the second facing portion are provided so that a distance in the recording material conveying direction between the first facing portion and the second facing portion is greater than a distance in the recording material conveying direction between the first surface and the second surface by 0.02 to 0.16 mm.

The present disclosure provides a fixing device having a configuration further developed from the conventional configuration.

Features of the present disclosure will become apparent from the following description of embodiments with reference to the attached drawings. The following description of embodiments is described by way of example.

### BRIEF DESCRIPTION OF THE DRAWINGS

FIGS. 1A and 1B are perspective views each illustrating a fixing device according to a first embodiment.

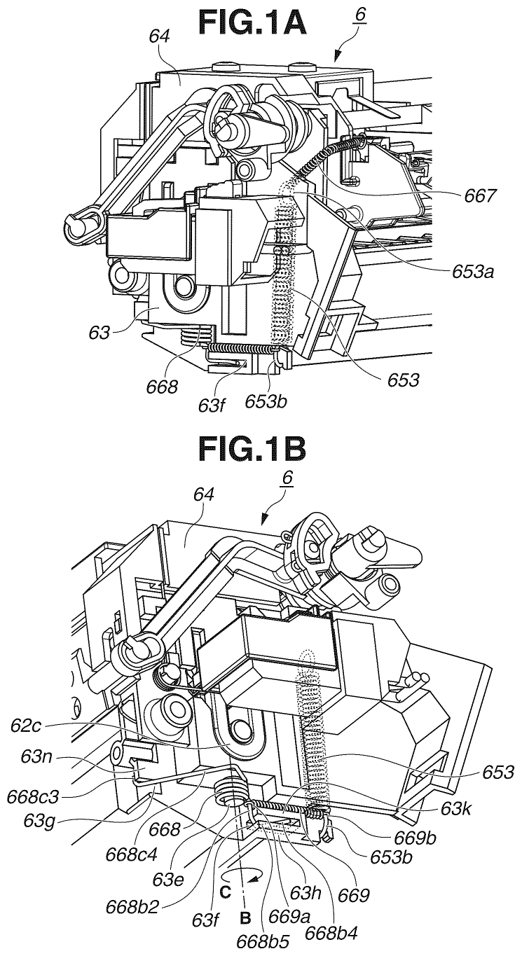

FIG. 2 is a cross-sectional view illustrating an image forming apparatus according to the first embodiment.

FIG. 3 is a cross-sectional view illustrating a heating unit and a pressure roller according to the first embodiment.

FIG. 4 is a cross-sectional view illustrating a fixing device according to the first embodiment.

FIG. 5 is an exploded perspective view illustrating the fixing device according to the first embodiment.

FIG. 6 is a top view illustrating a holder according to the first embodiment.

FIG. 7 is an exploded perspective view illustrating the heating unit according to the first embodiment.

FIG. 8 is a top view illustrating the heating unit according to the first embodiment.

FIG. 9A is a front view illustrating the fixing device according to the first embodiment. FIGS. 9B to 9D are cross-sectional views each illustrating the fixing device according to the first embodiment.

FIG. 10A is a top view illustrating a lower frame and the pressure roller according to the first embodiment. FIGS. 10B and 10C are enlarged views each illustrating the lower frame and the pressure roller according to the first embodiment.

FIG. 11A is a cross-sectional view illustrating a pressure mechanism and a pressure release mechanism in a pressured state according to the first embodiment. FIG. 11B is a cross-sectional view illustrating the pressure mechanism and the pressure release mechanism in a pressure release state according to the first embodiment.

FIG. 12 is an exploded perspective view illustrating the lower frame, an upper frame, a cam shaft, and a cam according to the first embodiment.

FIG. 13A is a front view illustrating the lower frame and the pressure roller according to the first embodiment. FIGS. 13B and 13C are cross-sectional views each illustrating the lower frame and the pressure roller according to the first embodiment.

FIG. 14A is a schematic view illustrating the pressure mechanism when the pressure roller is not driven according to the first embodiment. FIG. 14B is a schematic view illustrating the pressure mechanism when the pressure roller is driven according to the first embodiment.

FIG. 15A is a front view illustrating a holder according to a second embodiment. FIGS. 15B and 15C are cross-sectional views each illustrating the holder according to the second embodiment.

FIG. 16A is a side view illustrating a transmission member on a driven side. FIG. 16B is a side view illustrating the transmission member on a non-driven side.

FIG. 17A is a top view illustrating the holder and the transmission member according to the second embodiment. FIGS. 17B and 17C are cross-sectional views each illustrating the holder and the transmission member according to the second embodiment.

FIG. 18A is a schematic view illustrating a distance between the holder and the transmission member according to the second embodiment. FIG. 18B is a schematic view illustrating a distance between the holder and the transmission member according to a comparative example.

FIG. 19A is a side view illustrating a transmission member on a driven side according to a third embodiment. FIG. 19B is a side view illustrating the transmission member on a non-driven side according to the third embodiment.

### DESCRIPTION OF THE EMBODIMENTS

### First Embodiment

Embodiments of the present disclosure will be described in detail below with reference to the drawings.

### [Image Forming Apparatus]

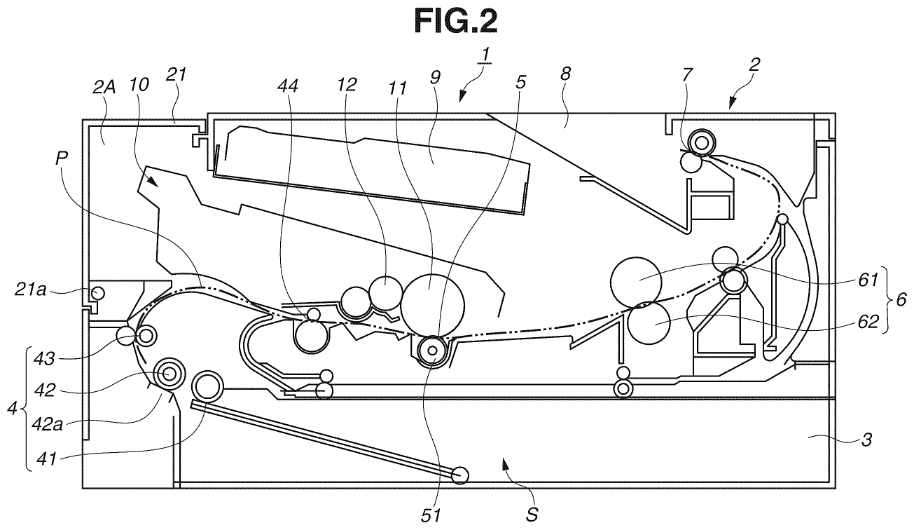

FIG. 2 is a cross-sectional view illustrating an image forming apparatus 1 using an electrophotography method according to a first embodiment. Dimensions, materials, shapes, relative positions, and the like of constituent elements described in the present embodiment may be changed as appropriate depending on a configuration of an apparatus to which the present disclosure is applied and various conditions. Thus, the scope of the present disclosure is not limited to these dimensions, materials, shapes, relative arrangement, and the like of constituent elements, unless specifically described. In the following description, the left side in FIG. 2 is defined as the front side of the image forming apparatus 1, the right side in FIG. 2 is defined as the back side of the image forming apparatus 1, the near side of the sheet is defined as the right side of the image forming apparatus 1, and the far side of the sheet is defined as the left side of the image forming apparatus 1. The upper side and the lower side in FIG. 2 are respectively defined as the upper side and lower side of the image forming apparatus 1.

As illustrated in FIG. 2, the image forming apparatus 1 includes an apparatus main body 2 and a process cartridge 10. The process cartridge 10 is detachably installed in the apparatus main body 2. The apparatus main body 2 is provided with a sheet feed tray 3, a recording material feed unit 4, a conveying path P, an image forming unit 5, a fixing device 6, a recording material discharge unit 7, a sheet discharge tray 8, a laser scanner 9, and the like. Meanwhile, the process cartridge 10 is provided with a photosensitive drum 11, a development roller 12 as a developer bearing member, and the like.

The apparatus main body 2 is provided with an opening/closing door 21 to close an opening portion 2A, which is provided to attach/detach the process cartridge 10. The opening/closing door 21 is supported so as to be able to pivot around a pivot axis 21a, and is movable between a closing position at which it closes the opening portion 2A and an open position at which it opens the opening portion 2A.

The recording material feed unit 4 includes a sheet feed roller 41, a separation roller 42, a separation pad 42a, and a conveyance roller pair 43. A recording material S accommodated in the sheet feed tray 3 is sent out by the recording material feed unit 4 to the conveying path P based on a print start signal, and conveyed to the image forming unit 5 through a registration roller pair 44. When the recording material S is conveyed to a predetermined position, an image formation start signal is given, and the image forming process is started. The photosensitive drum 11 rotationally driven by a drive source (motor), is uniformly charged to a predetermined potential by a charging unit. The surface of the photosensitive drum 11, after being charged, is exposed to light by the laser scanner 9 based on image information, charge on an exposed portion is removed, and an electrostatic image is formed. Toner in the process cartridge 10 is borne by the development roller 12 and supplied to the photosensitive drum 11 according to the electrostatic image, and a latent image is developed with toner. With this operation, the latent image is visualized as a toner image on the photosensitive drum 11.

The image forming unit 5 includes the process cartridge 10 and a transfer roller 51 that is disposed to face the photosensitive drum 11 included in the process cartridge 10. When the recording material S conveyed by the registration roller pair 44 reaches the image forming unit 5 and passes through a transfer nip portion between the photosensitive drum 11 and the transfer roller 51, a voltage is applied by the apparatus main body 2 to the transfer roller 51, and the toner image on the photosensitive drum 11 is transferred to the recording material S. Thereafter, the recording material S to which the toner image has been transferred is conveyed to the fixing device 6 provided with a heating unit 61 and a pressure roller 62 in contact with an outer peripheral surface of a tubular belt 614. When the recording material S is nipped and conveyed by a fixing nip portion NP1 between the heating unit 61 and the pressure roller 62, the toner image transferred onto the recording material S is heated, receives pressure, and is fixed to the surface of the recording material S. The recording material S onto which the toner image has been fixed passes through the recording material discharge unit 7, and is discharged to the sheet discharge tray 8.

### [Fixing Device]

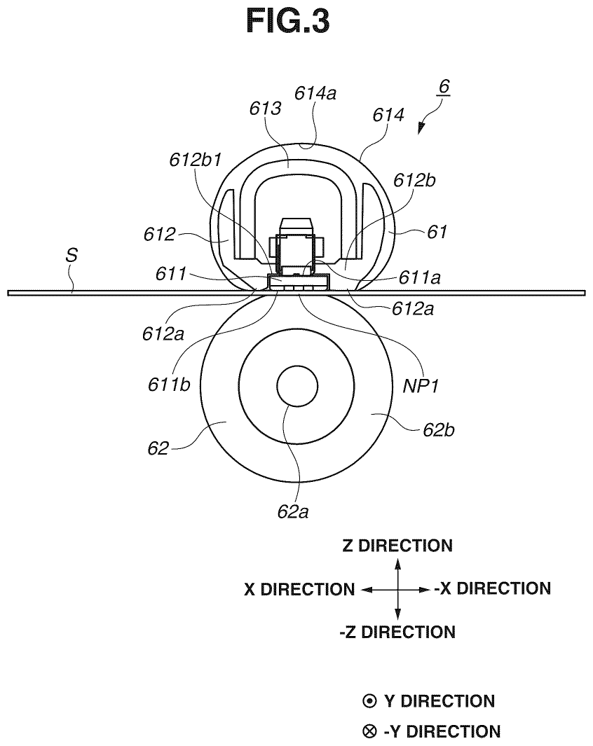

A specific configuration of the fixing device 6 is now described with reference to FIGS. 3 to 8. As illustrated in FIG. 3, the heating unit 61 included in the fixing device 6 is provided with a heater 611, a holder 612, a stay 613, and the belt 614. The heater 611, the holder 612, and the stay 613 are disposed in an internal space of the belt 614. Based on an X direction, a Y direction, and a Z direction as illustrated in FIG. 3, the heater 611 has a flat plate shape extending in the Y direction, and the Y direction coincides with a longitudinal direction of the heater 611. The heater 611 has a first surface 611a and a second surface 611b on the opposite side of the first surface 611a, and the first surface 611a is supported by the holder 612.

The holder 612 is formed of resin with heat resistance such as polyphenylene sulfide (PPS) resin or liquid crystal polymer resin, and has a guide surface 612a and a supporting wall 612b. The guide surface 612a comes in contact with an inner peripheral surface 614a of the belt 614 to guide the belt 614, and the supporting wall 612b has a supporting surface 612b1 that supports the heater 611. The supporting surface 612b1 of the supporting wall 612b is in contact with the first surface 611a of the heater 611. The stay 613 is a member that supports the holder 612, and is formed by bending a plate material into a substantially U-shape. The plate material has rigidity higher than that of the holder 612, and is, for example, a steel plate with a plate thickness of 1.6 mm.

The belt 614 is an endless belt having heat resistance and flexibility. Examples of the belt 614 include a belt in which a metal sleeve made of stainless steel or the like is covered with fluorine resin, and a belt on which polyimide resin, silicone rubber, fluorine resin, or the like is laminated. The heater 611, the holder 612, and the stay 613 are disposed inside the belt 614, and the belt 614 rotates around the heater 611, the holder 612, and the stay 613. The inner peripheral surface 614a of the belt 614 comes in contact with the second surface 611b of the heater 611.

The pressure roller 62 includes a shaft 62a made of metal and a roller 62b made of an elastic body that covers the shaft 62a, and is pressed against the heater 611 via the belt 614. The pressure roller 62 and the heater 611 sandwich the belt 614 therebetween, and thereby form the fixing nip portion NP1 for nipping, heating, and applying pressure to the recording material S. That is, the pressure roller 62, together with the heater 611, heats and applies pressure to the recording material S in the fixing nip portion NP1.

The pressure roller 62 is configured to be rotationally driven by driving force being transmitted thereto from a drive source included in the image forming apparatus 1. With the rotational driving of the pressure roller 62, the belt 614 is driven to rotate by friction force with respect to the belt 614 or the recording material S nipped by the fixing nip portion NP1. With this operation, the recording material S to which the toner image has been transferred is conveyed between the pressure roller 62 and the heated belt 614, whereby the toner image is fixed by heat.

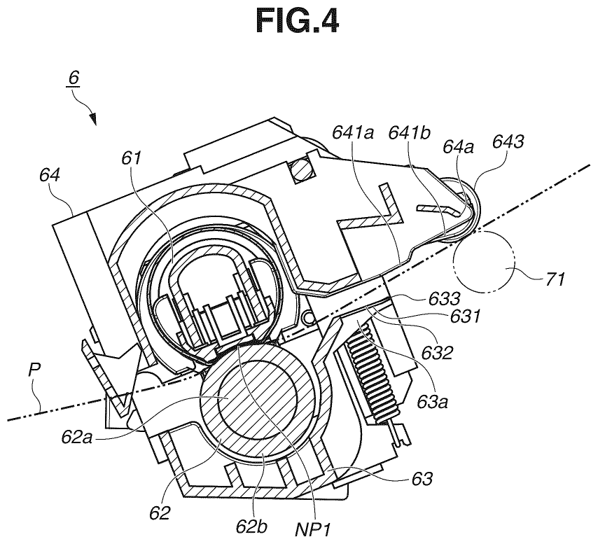

As illustrated in FIGS. 4 to 8, the fixing device 6 includes a lower frame 63 that supports the heating unit 61 and the pressure roller 62, and an upper frame 64 that is located above the lower frame 63 and that covers the heating unit 61. The upper frame 64 includes, on a downstream side of the heating unit 61 and the pressure roller 62 in the recording material conveying direction, an upper recording material guide 64a that guides an upper surface of the recording material S conveyed along the conveying path P. The lower frame 63 includes, on the downstream side of the heating unit 61 and the pressure roller 62 in the recording material conveying direction, a lower recording material guide 63a that guides a lower surface of the recording material S conveyed along the conveying path P.

The conveying path P in the fixing device 6 extends in the X direction. In the present embodiment, each of the lower frame 63 and the upper frame 64 is formed of, for example, a non-conductive mold member. Examples of a material of the mold member include polyethylene terephthalate (PET), polybutylene telephthalate (PBT), and PPS. PET or PBT may be strengthened by glass fibers.

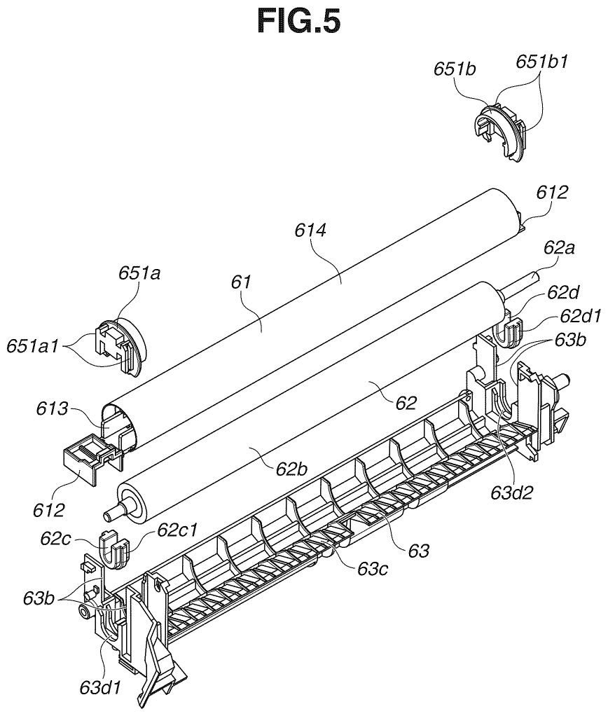

As illustrated in FIG. 5, the lower frame 63 supports the heating unit 61 and the pressure roller 62. The lower frame 63 includes a pair of rails 63b at each of two ends in the Y direction (longitudinal direction). The rails 63b support the holder 612 so that the holder is movable in the Z direction (first direction) via transmission members 651a and 651b, which are members that transmit pressure to the stay 613, as described below.

Each rail 63b is a columnar portion that extends from a main body 63c of the lower frame 63 in the Z direction. The paired rails 63b face each other in the X direction. Facing surfaces of the rails 63b are engaged with respective groove portions 651a1 provided in the transmission member 651a. Facing surfaces of the rails 63b are engaged with respective groove portions 651b1 provided in the transmission member 651b. While each rail 63b is the columnar portion that extends in the Z direction in the present embodiment, each rail 63b is only required to have a shape that can support the holder 612 so that the holder is movable in the Z direction, and the shape thereof is not limited to the shape in the present embodiment.

The pressure roller 62 is rotatably held by the lower frame 63 via bearings 62c and 62d at respective ends of the metal shaft 62a in the longitudinal direction. At this time, a protruding portion 62c1 provided on the bearing 62c is fitted to a groove portion 63d1 provided in the lower frame 63, whereby the position of the bearing 62c is determined. Similarly, a protruding portion 62d1 provided on the bearing 62d is fitted to a groove portion 63d2 provided in the lower frame 63, whereby the position of the bearing 62d is determined. The bearing 62c is formed of a conductive material. While the protruding portions 62c1 and 62d1 are respectively provided on the bearings 62c and 62d and the groove portions 63d1 and 63d2 are provided in the lower frame 63 in the present embodiment, respective groove portions may be provided in the bearings 62c and 62d and protruding portions may be provided on the lower frame 63.

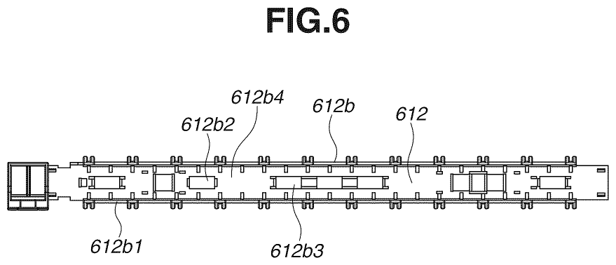

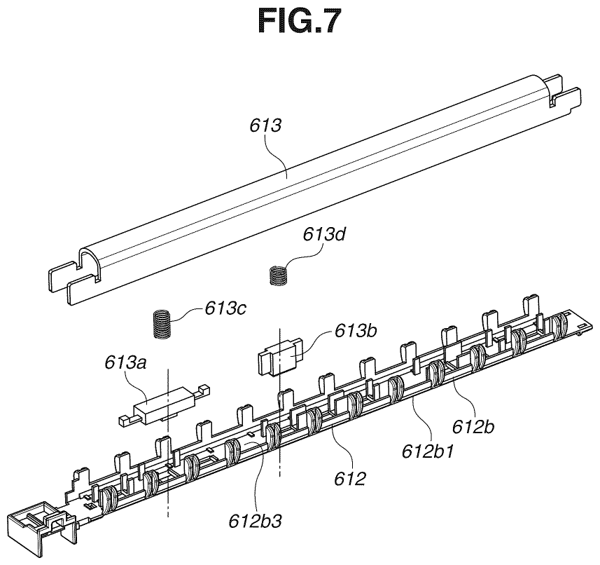

As illustrated in FIG. 6, the supporting wall 612b of the holder 612 includes a plurality of holes, holes 612b2 and 612b3. As illustrated in FIG. 6, temperature sensors 613a and 613b are provided so as to face a back surface 612b4 of the holder 612 on the opposite side of the supporting surface 612b1 of the holder 612. As illustrated in FIG. 7, the temperature sensors 613a and 613b come in contact with the first surface 611a of the heater 611 through the holes 612b2 and 612b3, respectively. The temperature sensors 613a and 613b are pressed against the first surface 611a of the heater 611 (refer to FIG. 3) by an urging member 613c provided between the stay 613 and the temperature sensor 613a and an urging member 613d provided between the stay 613 and the temperature sensor 613b. The temperature sensor 613a is located at one end of the holder 612 in the Y direction. The temperature sensor 613b is located at a position closer to the one end of the holder 612 than a middle of the holder 612 in the Y direction. Each of the temperature sensors 613a and 613b is a thermistor in the present embodiment but may be another temperature sensor such as a thermostat. Each of the urging members 613c and 613d is a coil spring in the present embodiment but may be another urging member.

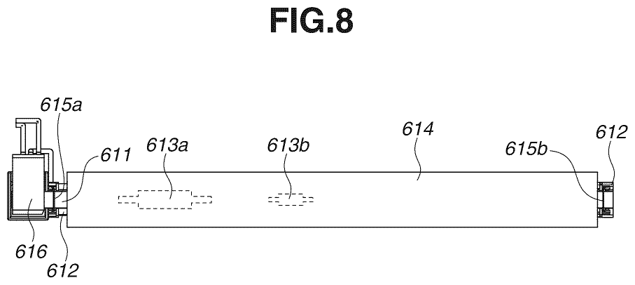

As illustrated in FIGS. 5 and 8, the holder 612 extends thorough the inside of the belt 614 in the Y direction, and two ends of the holder 612 in the Y direction protrude outward from the belt 614. The holder 612 supports the heater 611, and one end of the heater 611 in the Y direction is provided with a first wire spring 615a for holding the heater 611 with the holder 612 and a connector 616 that supplies power to the heater 611 and that clamps the heater 611 and the holder 612. The other end of the heater 611 in the Y direction is provided with a second wire spring 615b for holding the heater 611 with the holder 612.

The temperature sensors 613a and 613b are located at positions closer to the first wire spring 615a than they are to the second wire spring 615b in the Y direction. The first wire spring 615a is provided between the belt 614 and the connector 616. The second wire spring 615b is provided in a region outside the belt 614 on the other end side of the heater, which is the opposite side of the one end at which the first wire spring 615a is disposed. In the present embodiment, the pressure roller 62 is provided with the shaft 62a and the roller 62b. However, a configuration is not limited to the example, and the pressure roller 62 may be provided with a pressure belt that is pressed against a heating roller by an elastic member.

### [Pressure Mechanism]

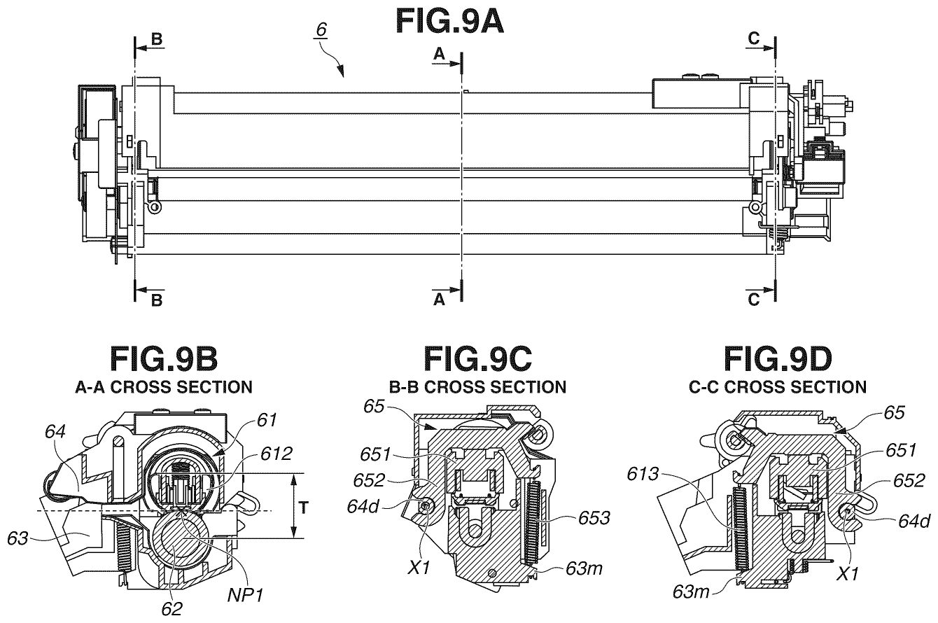

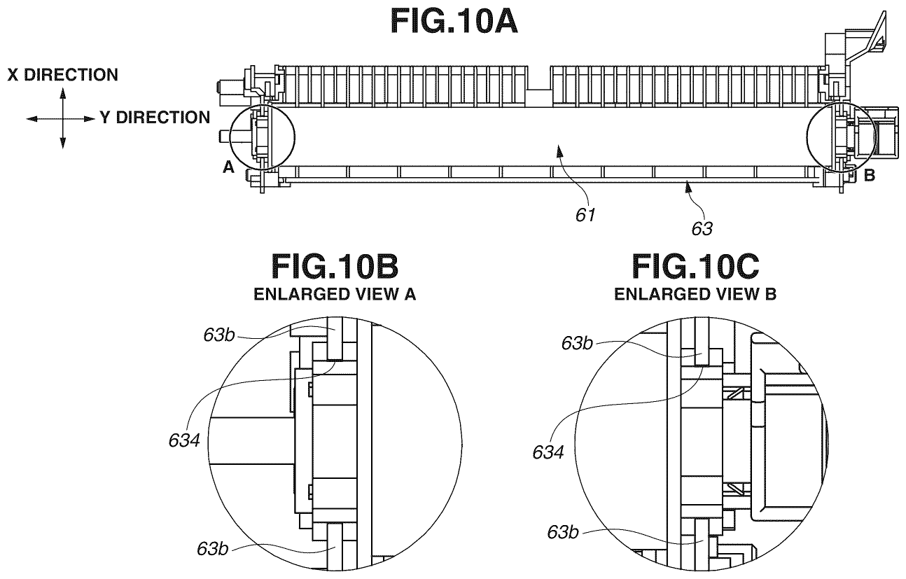

As illustrated in FIGS. 9A to 9D and 10A to 10C, the fixing device 6 includes a pressure mechanism 65 that applies pressure to form the fixing nip portion NP1 between the heating unit 61 and the pressure roller 62. The pressure mechanism 65 is located at each end of the lower frame 63 in the Y direction. Since respective structures of the pressure mechanisms 65 on one side and the other side in the Y direction are substantially identical, the structure on the one side in the Y direction is mainly described.

The pressure mechanism 65 is provided with a member (transmission member 651) that supports the heating unit 61 at its end in the Y direction and that transmits pressure to the stay 613 supported by the rails 63b so that the stay 613 is movable in the Z direction. The pressure mechanism 65 is provided with a pressure arm 652 for applying pressure to form the fixing nip portion NP1 to the transmission member 651 mounted on the lower frame 63. Additionally, the pressure mechanism 65 is provided with a pressure spring 653 that spans across the lower frame 63 and the pressure arm 652, and that generates pressure to press the pressure arm 652 against the transmission member 651. The lower frame 63 includes a supporting portion 64d that supports the pressure arm 652 so as to allow the pressure arm 652 to pivot around a pivot central axis X1. The supporting portion 64d is a substantially columnar protrusion. The pressure spring 653 is a tension coil spring that urges the pressure arm 652 toward the pressure roller 62. The lower frame 63 includes a spring hook portion 63m on which one end of the pressure spring 653 is hooked. For example, a part of the supporting portion 64d in the lower frame 63 made of resin may be made of metal, and a metal member may be attached to only a part of the supporting portion 64d in contact with the pressure arm 652. The spring hook portion 63m in the lower frame 63 made of resin may be made of metal.

At least a part of the pivot central axis X1 around which the pressure arm 652 pivots is located on the upstream side of the fixing nip portion NP1 in the recording material conveying direction when viewed in the Y direction and in a range T in the Z direction illustrated in FIG. 9B. Here, the range T in the Z direction illustrated in FIG. 9B is between the rotation center of the pressure roller 62 in the Z direction and the end of the holder 612 on the pressure arm side in the Z direction (the end of the holder 612 located farthest from the rotation center of the pressure roller 62 in the Z direction). Because there is a distance in the Z direction between a location at which the pressure arm 652 applies pressure to the transmission member 651 and the pivot central axis X1, the pressure arm 652 is bent in an L-shape. The above-mentioned upstream side in the recording material conveying direction is closer to the photosensitive drum 11 than the fixing nip portion NP1 in the X direction.

### [Pressure Release Mechanism]

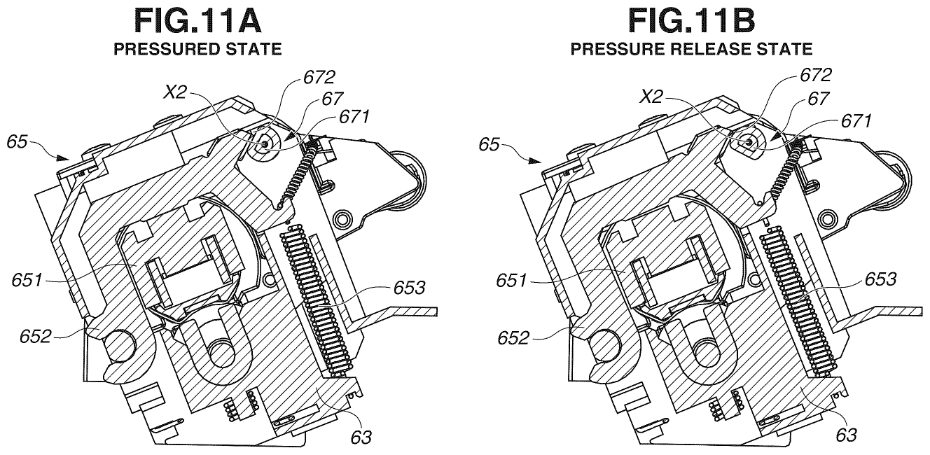

As illustrated in FIGS. 11A and 11B, the fixing device 6 further includes a pressure release mechanism 67 that releases nip pressure applied to the fixing nip portion NP1 between the heating unit 61 and the pressure roller 62 illustrated in FIG. 9A. The pressure release mechanism 67 includes a cam shaft 671 and a cam 672. The lower frame 63 supports the pressure spring 653 and also supports the pressure arm 652 and the cam 672 so as to allow the pressure arm 652 and the cam 672 to pivot. The cam 672 is located at each end of the lower frame 63 in the Y direction. Since respective structures of the pressure release mechanisms 67 on one side and the other side in the Y direction are substantially identical, the structure on the one side in the Y direction is representatively described.

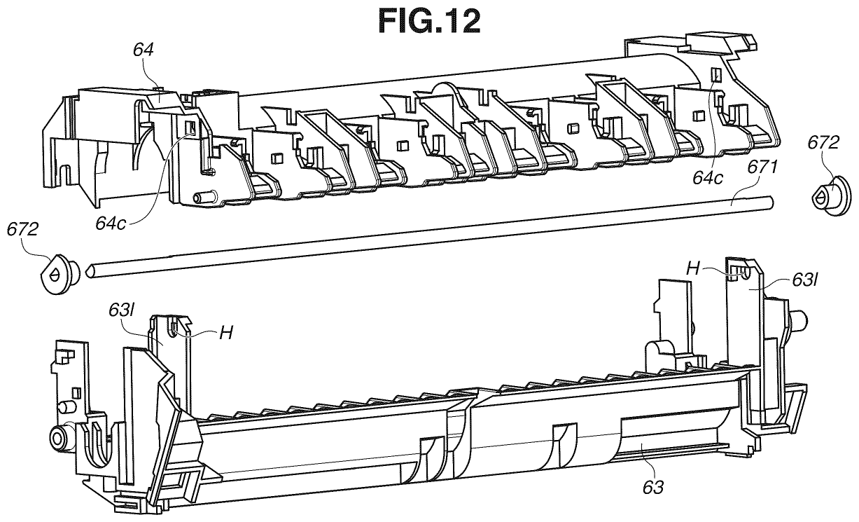

As illustrated in FIG. 12, the cam shaft 671 extends in the Y direction. The cam shaft 671 is made of, for example, metal. The respective cams 672 are fixed to two ends of the cam shaft 671 in the Y direction. In other words, the cams 672 include the cam shaft 671. Each cam 672 pivots with the pivoting of the cam shaft 671. The lower frame 63 includes shaft supporting portions 631 that support the cam shaft 671 so as to allow the cam shaft 671 to pivot. As illustrated in FIG. 12, the respective shaft supporting portions 631 are disposed at one end and the other of the lower frame 63 in the Y direction. Each shaft supporting portion 631 includes a hole H that supports the cam shaft 671 so as to allow the cam shaft 671 to pivot.

As illustrated in FIG. 12, the upper frame 64 includes grooves 64C that support the cam shaft 671 so as to allow the cam shaft 671 to pivot. The respective grooves 64C are disposed at one end and the other end of the upper frame 64 in the Y direction. The cam shaft 671 is held between the upper frame 64 and the lower frame 63. As illustrated in FIGS. 11A and 11B, the cam shaft 671 is supported so as to be able to pivot around an axis X2. The cam 672 is capable of pressing the pressure arm 652 by resisting urging force of the pressure spring 653. Specifically, the cam 672 is capable of pivoting between a first position illustrated in FIG. 11A and a second position illustrated in FIG. 11B.

### [Transmission Member and Lower Frame]

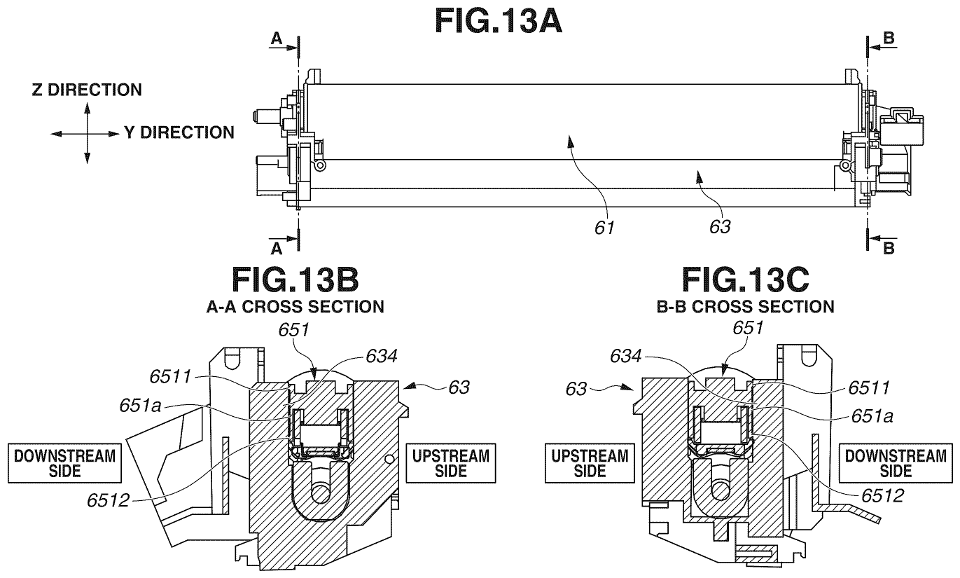

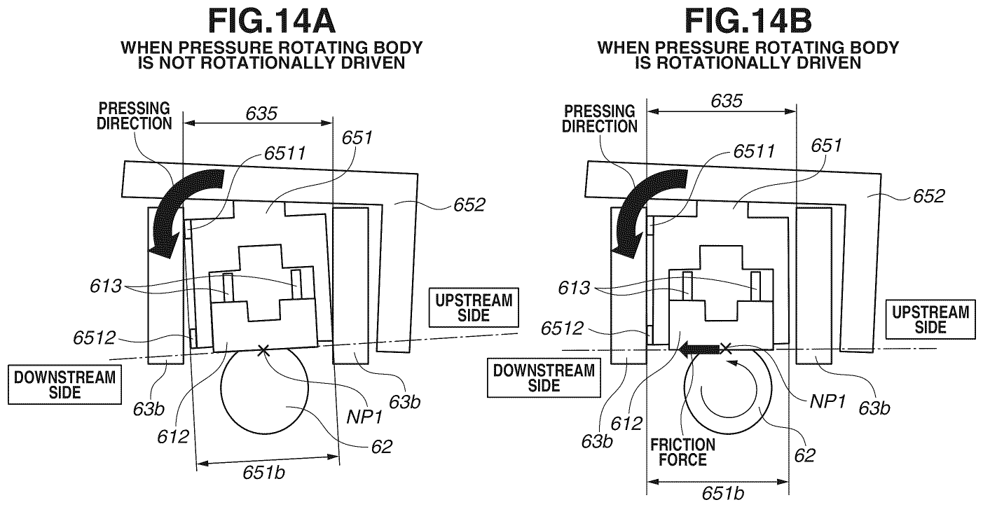

As illustrated in FIGS. 10A to 10C, 11A, 11B, 12, 13A to 13C, 14A, and 14B, the transmission member 651 is mounted on a recess portion that includes the rails 63b and that is provided in the lower frame 63. The transmission member 651 includes a transmission member 651a that faces, out of edges of each rail 63b, an edge 634 located on the downstream side of the fixing nip portion NP1 in the recording material conveying direction. The transmission member 651a is provided with a first protrusion 6511 and a second protrusion 6512. The second protrusion 6512 is provided at a position different from a position of the first protrusion 6511 in a mounting direction (Z direction) of the transmission member 651 with respect to the lower frame 63, and protrudes toward the edge 634 of the lower frame 63. Because a first distance 635 between the rails 63b in the X direction is greater than a first width 651b of the transmission member 651 in the X direction, the transmission member 651 has an orientation of being inclined in a pressing direction illustrated in FIG. 14A due to application of pressure by the pressure arm 652 before rotational driving of the pressure roller 62.

When the pressure roller 62 is rotationally driven in a state where the fixing nip portion NP1 is formed, as illustrated in FIG. 14B, the heating unit 61 receives force toward the downstream side in the recording material conveying direction due to friction force with respect to the recording material S sandwiched by the belt 614 or the fixing nip portion NP1. At this time, both the first protrusion 6511 and second protrusion 6512 of the transmission member 651 come in contact with the edge 634 of the lower frame 63, whereby the orientation of the heating unit 61 with respect to the lower frame 63 is defined, which stabilizes the fixability and conveyability of the fixing device 6. Here, the first protrusion 6511 and the second protrusion 6512 may be provided at both ends of the transmission member 651a in the Z direction. Providing the first protrusion 6511 and the second protrusion 6512 at both ends of the transmission member 651a in the Z direction makes it possible to decrease the inclination of the transmission member 651 even if there is a difference in an amount of protrusion toward the downstream side in the recording material conveying direction between the first protrusion 6511 and the second protrusion 6512 due to a dimensional tolerance.

### Second Embodiment

Constituent elements and control that are identical to those in the first embodiment are denoted by the same reference numbers and, for conciseness, a description thereof is incorporated by reference without being repeated.

### [Transmission Member and Holder]

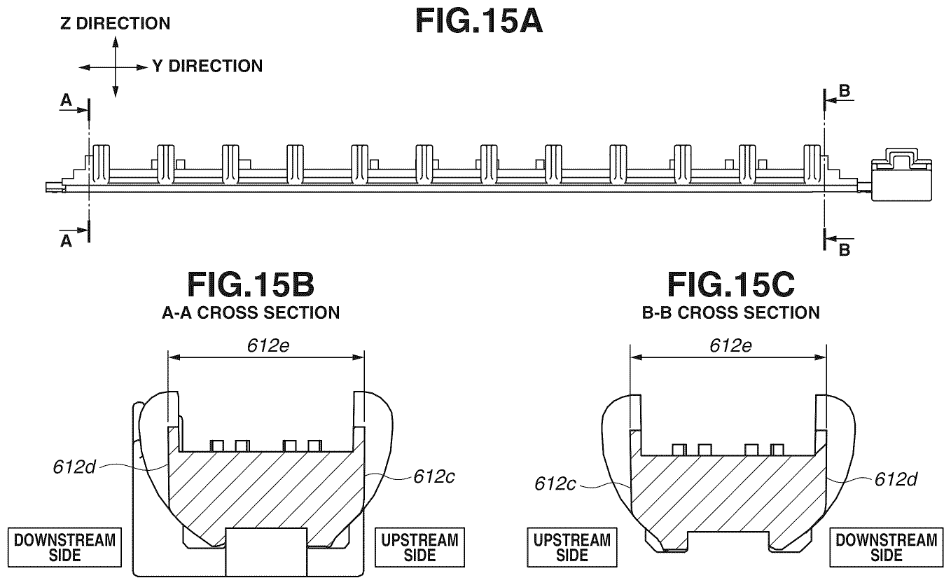

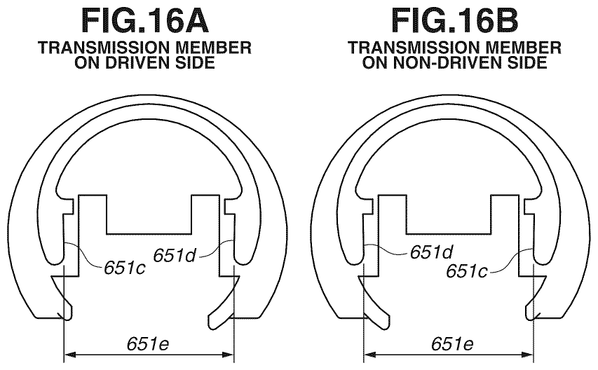

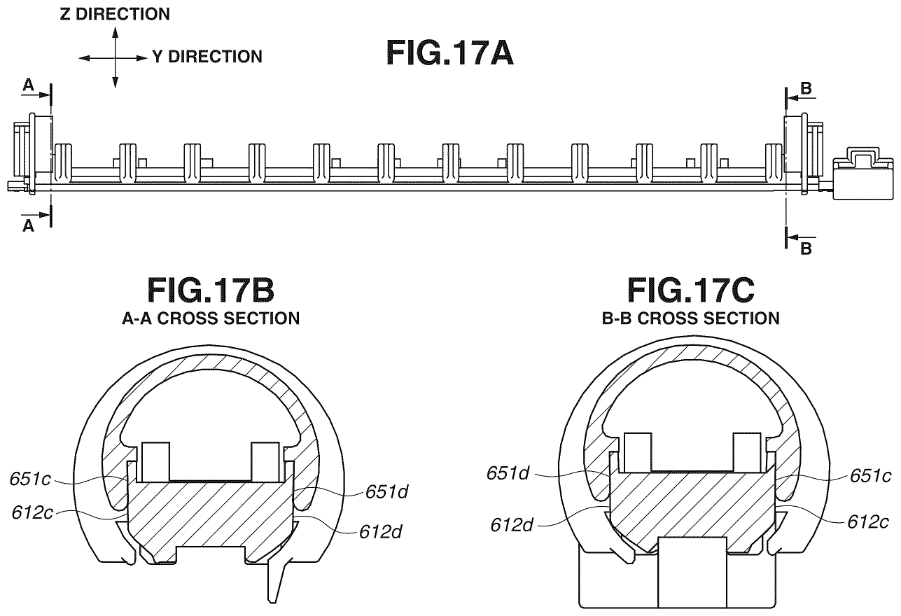

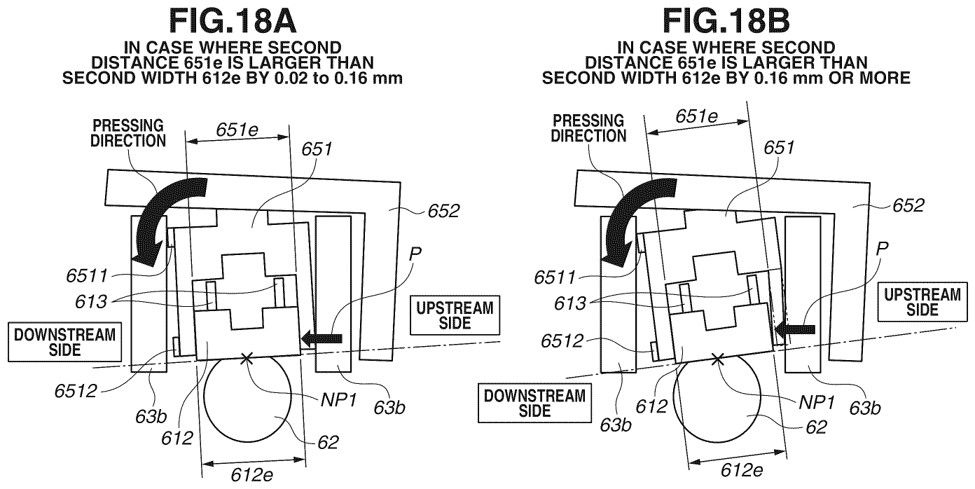

As illustrated in FIGS. 15A to 15C, 16A, 16B, 17A to 17C, 18A, and 18B, the holder 612 has a first surface 612c on the upstream side of the fixing nip portion NP1 in the recording material conveying direction and a second surface 612d on the downstream side of the fixing nip portion NP1 in the recording material conveying direction. The transmission member 651 faces each of the first surface 612c and the second surface 612d, and is assembled to the holder 612 via a first facing portion 651c and a second facing portion 651d respectively located on the upstream side and the downstream side in the recording material conveying direction. A second width 612e between the first surface 612c and the second surface 612d in the recording material conveying direction is smaller than a distance (second distance) 651e between the first facing portion 651c on the upstream side and the second facing portion 651d on the downstream side in the recording material conveying direction by 0.02 to 0.16 mm. FIG. 18A illustrates a case where the second distance 651e is greater than the second width 612e by 0.02 to 0.16 mm, and FIG. 18B illustrates a case where the second distance 651e is greater than the second width 612e by 0.16 mm or more. The present embodiment corresponds to FIG. 18A. When the transmission member 651 receives pressure from the pressure arm 652, the transmission member 651 is inclined in the pressing direction illustrated in FIGS. 18A and 18B and comes into contact with the lower frame 63, whereby the first facing portion 651c receives force P in a direction toward the fixing nip portion NP1 from the lower frame 63. At this time, narrowing a gap between the holder 612 and the transmission member 651 suppresses the inclination of the transmission member 651 with respect to the lower frame 63 as illustrated in FIG. 18A, and suppresses deformation of the first facing portion 651c by being pressed by the force P in the direction toward the fixing nip portion NP1.

The description has been given assuming that the first surface 612c and the second surface 612d are included in the holder 612, but the present disclosure is not limited to this configuration. As the present disclosure, a difference between the second distance 651e between the first facing portion 651c and the second facing portion 651d included in the transmission member 651 and a width of a member adjacent to the first facing portion 651c and the second facing portion 651d is only required to be 0.02 to 0.16 mm. For example, like the present embodiment, the stay 613 may include respective portions corresponding to the first surface 612c and the second surface 612d, and the stay 613 may be assembled to the transmission member 651.

### Third Embodiment

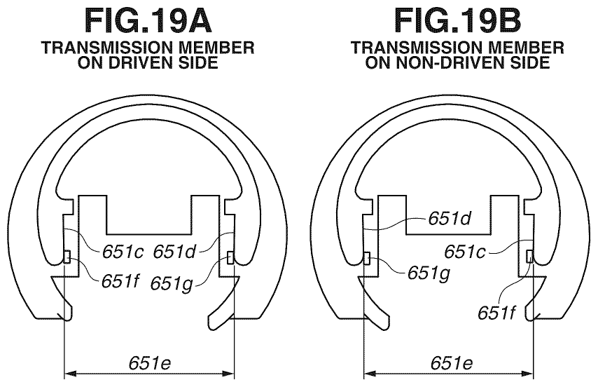

In a third embodiment, constituent elements and control that are identical to those in the first and second embodiment are denoted by the same reference numbers, and, for conciseness, a description thereof is incorporated by reference without being repeated. In the present embodiment, as illustrated in FIGS. 19A and 19B, a first protruding portion 651f and a second protruding portion 651g are respectively provided at a bottom end of the first facing portion 651c and a bottom end of the second facing portion 651d in the Z direction. With the provision of the first protruding portion 651f and the second protruding portion 651g, even in a case where there is a bulge on a surface of the first facing portion 651c or a surface of the second facing portion 651d due to a dimensional tolerance, a part corresponding to the first surface 612c and a part corresponding to the second surface 612d can serve as the first protruding portion 651f and the second protruding portion 651g, respectively. This makes it possible to suppress an error in positional relationship between the transmission member 651 and the holder 612.

### [Additional Note]

The embodiments described herein include the following configuration examples and method examples.

### (Item 1)

A fixing device including:
a heating unit including:
   a belt having a tubular shape;
   a heater disposed in an internal space of the belt;
   a holder configured to hold the heater;
   a stay that is disposed to be in contact with the holder and that is configured to reinforce the holder; and
   a transmission member that is disposed, when viewed from a direction orthogonal to a longitudinal direction of the belt, at a position overlapping with both ends of the stay in the longitudinal direction, and that is configured to transmit, to the stay, pressure in a direction from the stay toward the heater;
a pressure roller that is in contact with an outer peripheral surface of the belt, and that is configured to sandwich the belt between the pressure roller and the heater and form a fixing nip portion between the pressure roller and the belt; a frame configured to hold the heating unit by holding the pressure roller so as to allow the pressure roller to rotate and also holding the transmission member, and includes a recess portion to mount the transmission member; and
a pressure arm that is pivotably provided in the frame and that is configured to apply the pressure to the transmission member mounted on the frame, in which
the fixing device is configured to fix a toner image formed on a recording material to the recording material while nipping and conveying the recording material in the fixing nip portion formed by the pressure,
a material of the frame is resin,
the frame has a pivot central axis to support pivoting of the pressure arm, when viewed from the longitudinal direction, the pivot central axis is located on an upstream side of the fixing nip portion in a recording material conveying direction and between, in a first direction orthogonal to the longitudinal direction and the recording material conveying direction, a rotation center of the pressure roller and an end of the holder that is farthest from the rotation center of the pressure roller in the first direction,
the transmission member includes a facing portion configured to face, out of edges forming the recess portion of the frame, an edge located on a downstream side of a center of the fixing nip portion in the recording material conveying direction, the facing portion is provided with a first protrusion that protrudes toward the edge on the downstream side in the recording material conveying direction and a second protrusion that is provided at a position different from a position of the first protrusion in the first direction and that protrudes toward the edge on the downstream side in the recording material conveying direction, and
when the pressure roller rotates in a state where the fixing nip portion is formed, both the first protrusion and the second protrusion are configured to come in contact with the edge on the downstream side in the recording material conveying direction.

### (Item 2)

The fixing device according to Item 1, in which the first protrusion and the second protrusion are provided at both ends of the facing portion in the first direction.

### (Item 3)

The fixing device according to Items 1 and 2, in which the pressure arm is bent in an L-shape when viewed in the longitudinal direction.

### (Item 4)

The fixing device according to Items 1 to 3, in which a spring configured to generate the pressure between the pressure arm and the frame is hooked on the downstream side of the fixing nip portion in the recording material conveying direction.

### (Item 5)

The fixing device according to Items 1 to 4, in which, out of a supporting portion configured to support the pressure arm on the pivot central axis, a part in contact with the pressure arm is made of metal.

### (Item 6)

The fixing device according to Items 1 to 5, in which a metal member is attached to a part of the frame on which the spring is hooked.

### (Item 7)

A fixing device including:
a heating unit including:
   a belt having a tubular shape;
   a heater disposed in an internal space of the belt;
a holder configured to hold the heater;
a stay that is disposed to be in contact with the holder and that is configured to reinforce the holder; and
   a transmission member that is disposed, when viewed from a direction orthogonal to a longitudinal direction of the belt, at a position overlapping with both ends of the stay in the longitudinal direction, and that is configured to transmit, to the stay, pressure in a direction from the stay toward the heater;
a pressure roller that is in contact with an outer peripheral surface of the belt, and that is configured to sandwich the belt between the pressure roller and the heater and form a fixing nip portion between the pressure roller and the belt;
a frame configured to hold the heating unit by holding the pressure roller so as to allow the pressure roller to rotate and also holding the transmission member; and
a pressure arm that is pivotably provided in the frame and that is configured to apply the pressure to the transmission member mounted on the frame, in which
the fixing device is configured to fix a toner image formed on a recording material to the recording material while nipping and conveying the recording material in the fixing nip portion formed by the pressure,
a material of the frame is resin,
the frame includes a pivot central axis to support pivoting of the pressure arm,
when viewed from the longitudinal direction, the pivot central axis is located on an upstream side of the fixing nip portion in a recording material conveying direction and between, in a first direction orthogonal to the longitudinal direction and the recording material conveying direction, a rotation center of the pressure roller and an end of the holder that is farthest from the rotation center of the pressure roller in the first direction,
the holder includes, at a position at which the transmission member is provided in the longitudinal direction, a first surface located on the upstream side of the fixing nip portion in the recording material conveying direction and a second surface located on a downstream side of the fixing nip portion in the recording material conveying direction,
the transmission member includes a first facing portion provided on the upstream side of the first surface in the recording material conveying direction and facing the first surface, and a second facing portion provided on the downstream side of the second surface in the recording material conveying direction and facing the second surface, and
the first facing portion and the second facing portion are provided so that a distance in the recording material conveying direction between the first facing portion and the second facing portion is greater than a distance in the recording material conveying direction between the first surface and the second surface by 0.02 to 0.16 mm.

### (Item 8)

The fixing device according to Item 7, in which
the first facing portion includes a first protruding portion that is provided in a position closest to the pressure roller in the first direction and that protrudes toward the first surface, and
the second facing portion includes a second protruding portion that is provided in a position closest to the pressure roller in the first direction and that protrudes toward the second surface.

### (Item 9)

The fixing device according to Items 7 and 8, in which the pressure arm is bent in an L-shape when viewed from the longitudinal direction.

### (Item 10)

The fixing device according to Items 7 to 9, in which a spring configured to generate the pressure between the pressure arm and the frame is hooked on the downstream side of the fixing nip portion in the recording material conveying direction.

### (Item 11)

The fixing device according to Items 7 to 10, in which, out of a supporting portion configured to support the pressure arm on the pivot central axis, a part in contact with the pressure arm is made of metal.

### (Item 12)

The fixing device according to Items 7 to 11, in which a metal member is attached to a part of the frame on which the spring is hooked.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims priority to and the benefit of Japanese Patent Application No. 2024-164403, filed Sep. 20, 2024, which is hereby incorporated by reference herein in its entirety.

What is claimed is:

1. A fixing device comprising:
a heating unit including:
a belt having a tubular shape;
a heater disposed in an internal space of the belt;
a holder configured to hold the heater;
a stay that is disposed to be in contact with the holder and that is configured to reinforce the holder, the stay including a first end and a second end arranged along the longitudinal direction; and
a transmission member that is disposed, when viewed from a direction orthogonal to a longitudinal direction of the belt, at a position overlapping with the first end and the second end of the stay, and that is configured to apply, to the stay, pressure in a direction from the stay toward the heater;
a pressure roller that is in contact with an outer peripheral surface of the belt, wherein the belt is sandwiched between the pressure roller and the heater, forming a fixing nip portion between the pressure roller and the belt;
a frame configured to hold the heating unit by holding the pressure roller so as to allow the pressure roller to rotate and to hold the transmission member, the frame including a recess portion to mount the transmission member; and
a pressure arm that is pivotably provided in the frame and that is configured to apply the pressure to the transmission member mounted on the frame,
wherein the fixing device is configured to fix a toner image to the recording material while nipping and conveying the recording material in the fixing nip portion,
wherein a material of the frame is resin,
wherein the frame has a pivot central axis to support pivoting of the pressure arm,
wherein, when viewed from the longitudinal direction, the pivot central axis is located on an upstream side of the fixing nip portion in a recording material conveying direction and between, in a first direction orthogonal to the longitudinal direction and the recording material conveying direction, a rotation center of the pressure roller and an end of the holder positioned away from the rotation center of the pressure roller in the first direction,
wherein the transmission member includes a facing portion configured to face, from among a plurality of edges forming the recess portion of the frame, an edge located on a downstream side of a center of the fixing nip portion in the recording material conveying direction,
wherein the facing portion is provided with a first protrusion that protrudes toward the edge located on the downstream side in the recording material conveying direction and a second protrusion that is provided at a position different from a position of the first protrusion in the first direction and that protrudes toward the edge located on the downstream side in the recording material conveying direction, and
wherein, when the pressure roller rotates in a state where the fixing nip portion is formed, both the first protrusion and the second protrusion are configured to contact with the edge located on the downstream side in the recording material conveying direction.

2. The fixing device according to claim 1, wherein the first protrusion and the second protrusion are provided at both ends of the facing portion in the first direction.

3. The fixing device according to claim 1, wherein the pressure arm is bent in an L-shape when viewed in the longitudinal direction.

4. The fixing device according to claim 3, further comprising a spring configured to generate the pressure between the pressure arm and the frame, wherein the spring is hooked on the downstream side of the fixing nip portion in the recording material conveying direction.

5. The fixing device according to claim 4, wherein, further comprising a supporting portion configured to support the pressure arm on the pivot central axis, wherein a part of the supporting portion in contact with the pressure arm is made of metal.

6. The fixing device according to claim 5, further comprising a metal member attached to a part of the frame on which the spring is hooked.

7. A fixing device comprising:
a heating unit including:
a belt having a tubular shape;
a heater disposed in an internal space of the belt;
a holder configured to hold the heater;
a stay that is disposed to be in contact with the holder and that is configured to reinforce the holder, the stay including a first end and a second end arranged along the longitudinal direction; and
a transmission member that is disposed, when viewed from a direction orthogonal to a longitudinal direction of the belt, at a position overlapping with the first end and the second end of the stay, and that is configured to apply, to the stay, pressure in a direction from the stay toward the heater;
a pressure roller that is in contact with an outer peripheral surface of the belt, wherein the belt is sandwiched between the pressure roller and the heater, forming a fixing nip portion between the pressure roller and the belt;
a frame configured to hold the heating unit by holding the pressure roller so as to allow the pressure roller to rotate and to hold the transmission member; and
a pressure arm that is pivotably provided in the frame and that is configured to apply the pressure to the transmission member mounted on the frame,
wherein the fixing device is configured to fix a toner image to the recording material while nipping and conveying the recording material in the fixing nip portion,
wherein a material of the frame is resin,
wherein the frame includes a pivot central axis to support pivoting of the pressure arm,
wherein, when viewed from the longitudinal direction, the pivot central axis is located on an upstream side of the fixing nip portion in a recording material conveying direction and between, in a first direction orthogonal to the longitudinal direction and the recording material conveying direction, a rotation center of the pressure roller and an end of the holder positioned away from the rotation center of the pressure roller in the first direction,
wherein the holder includes, at a position at which the transmission member is provided in the longitudinal direction, a first surface located on the upstream side of the fixing nip portion in the recording material conveying direction and a second surface located on a downstream side of the fixing nip portion in the recording material conveying direction,
wherein the transmission member includes a first facing portion provided on the upstream side of the first surface in the recording material conveying direction and facing the first surface, and a second facing portion provided on the downstream side of the second surface in the recording material conveying direction and facing the second surface, and
wherein the first facing portion and the second facing portion are provided so that a distance in the recording material conveying direction between the first facing portion and the second facing portion is greater than a distance in the recording material conveying direction between the first surface and the second surface by 0.02 to 0.16 mm.

8. The fixing device according to claim 7,
wherein the first facing portion includes a first protruding portion that is provided in a position closest to the pressure roller in the first direction and that protrudes toward the first surface, and
wherein the second facing portion includes a second protruding portion that is provided in a position closest to the pressure roller in the first direction and that protrudes toward the second surface.

9. The fixing device according to claim 7, wherein the pressure arm is bent in an L-shape when viewed from the longitudinal direction.

10. The fixing device according to claim 9, further comprising a spring configured to generate the pressure between the pressure arm and the frame, wherein the spring is hooked on the downstream side of the fixing nip portion in the recording material conveying direction.

11. The fixing device according to claim 10, wherein, further comprising a supporting portion configured to support the pressure arm on the pivot central axis, wherein a part of the supporting portion in contact with the pressure arm is made of metal.

12. The fixing device according to claim 11, further comprising a metal member attached to a part of the frame on which the spring is hooked.
